(19) United States
(12) Patent Application Publication
(10) Pub. No.: US 2025/0247114 A1
(43) Pub. Date: Jul. 31, 2025

(54) ELECTRONIC DEVICE

(71) Applicant: Lenovo (Beijing) Limited, Beijing (CN)

(72) Inventors: Xiaozhun SHEN, Beijing (CN); Weimin BAO, Beijing (CN)

(21) Appl. No.: 19/015,339

(22) Filed: Jan. 9, 2025

(30) Foreign Application Priority Data
Jan. 31, 2024 (CN) 202410140074.9

(51) Int. Cl. H04B 1/00

(52) U.S. Cl. CPC H04B 1/0053

(57) ABSTRACT

An electronic device includes a first body and a second body, the second body being configured to rotate relative to the first body, where the first body has a first conductor side wall, the second body has a second conductor side wall, and a gap is formed between the first conductor side wall and the second conductor side wall; the second conductor side wall has at least one accommodating space, each of the accommodating space has an opening in a direction perpendicular to the second conductor side wall, and a first radiator and a feeder are arranged in each of the accommodating spaces; and the first radiator radiates a signal of a first frequency band, the feeder is configured to feed power to the first conductor side wall to cause the second radiator to radiate a signal of a second frequency band.

### CROSS-REFERENCES TO RELATED APPLICATION

This application claims priority to Chinese Patent Application No. 202410140074.9 filed on Jan. 31, 2024, the entire content of which is incorporated herein by reference.

### FIELD OF TECHNOLOGY

The present disclosure relates to the field of electronic devices and, more specifically, to an electronic device with communication functions.

### BACKGROUND

Antenna is the core component of electronic devices to realize communication function, and antenna radiates signals through a radiator. The design of the radiator needs to take the surrounding environment into consideration. In particular, when a conductor is close to the radiator, the conductor will affect the near-field parameters of the radiator and may even cause the matching characteristics to deteriorate. In severe cases, the antenna may stop working.

For electronic devices with multi-band communication requirements, multiple radiators are required to radiate signals of corresponding frequency bands respectively, but these radiators need to be configured with multiple radiation environments to make them work properly. With the trend of miniaturization in electronic devices, the utilization of limited space in electronic devices to arrange multiple radiators to achieve multi-band communication needs to be improved.

### SUMMARY

One aspect of this disclosure provides an electronic device. The electronic device includes a first body and a second body. The second body is configured to rotate relative to the first body. The first body has a first conductor side wall, the second body has a second conductor side wall, and a gap is formed between the first conductor side wall and the second conductor side wall. The second conductor side wall has at least one accommodating space, each of the accommodating space has an opening in a direction perpendicular to the second conductor side wall, and a first radiator and a feeder are arranged in each of the accommodating space. The first radiator radiates a signal of a first frequency, the feeder is configured to feed power to the first conductor side wall to cause the second radiator to radiate a signal of a second frequency.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts and may be encompassed in the present disclosure.

The structure, scale, size, etc. shown in the drawings of this specification are for the purpose of only matching the content disclosed in the specification for those who are familiar with the technologies to understand and read, rather than limiting the conditions under which the present application is to be implemented, and therefore have no technical significance. Any modification to the structure, change to the scale or the size without affecting the functions and the purpose of the present application shall still fall within the scope covered by the embodiments disclosed in the present application.

FIG. 1 is a schematic structural diagram of an electronic device according to some embodiments of the present disclosure.

FIG. 2 is a cross-sectional view of the electronic device shown in FIG. 1 along a dotted line direction.

FIG. 3 is a top view of a second body in the electronic device shown in FIG. 1.

FIG. 4 is a front view of the electronic device shown in FIG. 1 facing a second conductor side wall.

FIG. 5 is a schematic diagram of a layout of a conductive member in an accommodating space according to some embodiments of the present disclosure.

FIG. 6 is a cross-sectional view of the electronic device in the accommodating space according to some embodiments of the present disclosure.

FIG. 7 is a cross-sectional view of an enlarged portion of the electronic device in a direction perpendicular to the second conductor side wall according to some embodiments of the present disclosure.

FIG. 8 is a top view of the electronic device according to some embodiments of the present disclosure.

FIG. 9 is another schematic structural diagram of the electronic device according to some embodiments of the present disclosure.

FIG. 10 is a cross-sectional view of the electronic device shown in FIG. 9 along the dotted line direction.

FIG. 11 is a cross-sectional view of the electronic device along the direction perpendicular to the second conductor side wall according to some embodiments of the present disclosure.

FIG. 12 is another schematic structural diagram of the electronic device according to some embodiments of the present disclosure.

FIG. 13 is another schematic structural diagram of the electronic device according to some embodiments of the present disclosure.

FIG. 14 is a front view of the electronic device facing the second conductor side wall according to some embodiments of the present disclosure.

FIG. 15 is a cross-sectional view of FIG. 14 along an A-A′ direction.

FIG. 16 illustrates a return loss curve of an antenna radiator.

FIG. 17 illustrates a reflection coefficient curve of the antenna radiator.

### DETAILED DESCRIPTION

The embodiments of the present disclosure are clearly and completely described below with reference to the accompanying drawings in the embodiments of the present disclosure. The described embodiments are only a part of the embodiments of the present disclosure, but not all of the embodiments. Based on the embodiments in the present disclosure, all other embodiments obtained by those of ordinary skill in the art without creative efforts shall fall within the protection scope of the present disclosure.

As described above, the design of the radiator needs to take the surrounding environment into consideration. In particular, when the conductor is close to the radiator, it will affect the near-field parameters of the radiator and even cause the matching characteristics to deteriorate. In severe cases, the antenna may fail to work. To avoid the influence of the metal shell of the device on the antenna performance, there is a need to design an antenna window on the metal shell of the device. Although this can solve the influence of the metal shell of the device on the antenna performance, the window opening process will not only increase the cost, but also affect the appearance of the device.

In view of the foregoing, in the present disclosure, the antenna radiator in the electronic device can be constructed based on a gap between two rotatable bodies in the electronic device. More specifically, there is a gap between the first conductor side wall and the second conductor side wall of the first body. A first antenna radiator and a feeder are arranged in the accommodating space of the second conductor side wall. The first antenna radiator is used to radiate a signal of a first frequency band, and a second radiator layer is formed through the feeder and the gap to radiator a signal of the second frequency band. In this way, not only can the multi-band signal radiation function be realized, but also the first radiator and the feeder can be arranged simultaneously based on the same accommodating space, thereby optimizing the layout space of the antenna radiator in the electronic device.

To make the above-mentioned objectives, features and advantages of the present disclosure more clearly understood, the present disclosure is further described in detail below with reference to accompanying drawings and embodiments.

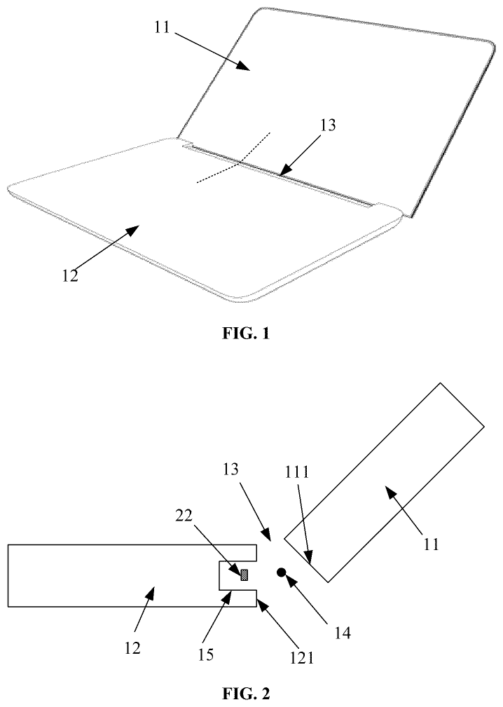

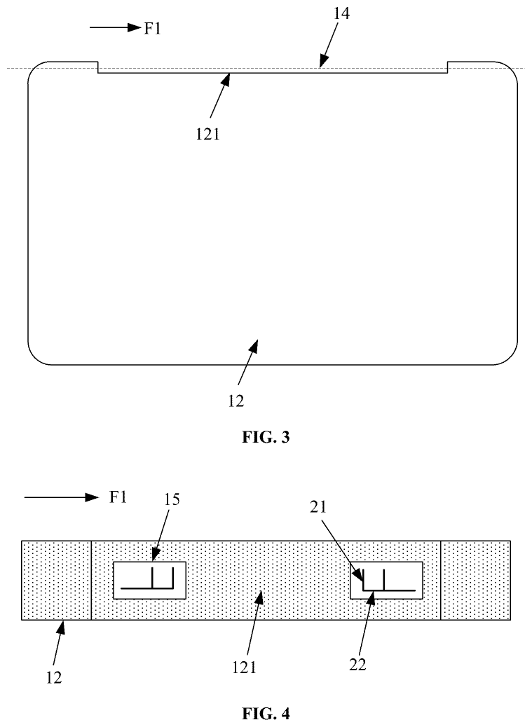

Refer to FIG. 1 to FIG. 4. FIG. 1 is a schematic structural diagram of an electronic device according to some embodiments of the present disclosure. FIG. 2 is a cross-sectional view of the electronic device shown in FIG. 1 along a dotted line direction. FIG. 3 is a top view of a second body in the electronic device shown in FIG. 1. FIG. 4 is a front view of the electronic device shown in FIG. 1 facing a side wall of a second conductor.

The electronic device includes a first body 11 and a second body 12. The second body 12 and the first body 11 can rotate relative to each other. The first body 11 has a first conductor side wall 111, the second body 12 has a second conductor side wall 121, and a gap 13 is formed between the first conductor side wall 111 and the second conductor side wall 121. The second conductor side wall 121 has at least one accommodating space 15, each accommodating space 15 has an opening in a direction perpendicular to the second conductor side wall 121. A first radiator 21 and a feeder 22 are arranged in each accommodating space. The radiator 21 radiates a signal of the first frequency band, and the feeder 22 is used to feed power to the first conductor side wall 111 such that the feeder 22 and the gap 13 form a second radiator, and the second radiator radiates a signal of a second frequency band.

In the electronic device provided in the embodiments of the present disclosure, the radiator 21 and the feeder 22 can be simultaneously arranged in the same accommodating space 15 of the second conductor side wall 121. The radiator 21 can radiate the signal of the first frequency band, and the feeder 22 can also feed the first conductor side wall with the signal of the first frequency band. In this way, the feeder 22 can form the second radiator with the gap 13 such that the signal of the second frequency band can be radiated through the second radiator. On the one hand, the electronic device can use the same accommodating space 15 to simultaneously arrange the radiator 21 and the feeder 22, which saves the layout space for arranging the antenna radiator in the electronic device. On the other hand, in the electronic device, the second radiator can be formed based on the feeder 22 and the gap 13, and different frequency band signals can be radiated by the radiator 21 and the second radiator respectively to realize multi-band wireless communication.

The signal of the first frequency band may be different from the signal of the second frequency band. The technical solution of the present disclosure can realize multi-band communication function based on the first radiator and the feeder located in the same accommodating space, optimize the layout space of the radiators radiating signals of different frequency bands, and improve the utilization rate of the internal space of the electronic device.

In some embodiments, the radiator 21 and the feeder 22 may both be connected to the radio frequency source in the second body 12. After the feeder 22 is connected to the radio frequency source, it can also radiate a portion of the signal of the second frequency band. The electronic device mainly meets the signal of the second frequency band communication requirements based on the second radiator composed of the feeder 22 and the gap 13. The feeder 22 alone may radiate a small portion of the signal of the second frequency band. In the embodiments of the present disclosure, the radiator 21 and the feeder 22 can be connected to the same radio frequency source or different radio frequency sources, and each radio frequency source may be disposed in the first body 11 or the second body 12 based on needs, which is not limited in the embodiments of the present disclosure.

In some embodiments, the first body 11 and the second body 12 may be relatively rotatable based on a shaft 14. It should be noted that the shaft 14 may be a virtual axis. In this case, the shaft 14 can be a reference axis of rotation when the first body 11 and the second body 12 rotate relative to each other. The shaft 14 may be defined based on a mechanical rotation connection between the first body 11 and the second body 12. In other embodiments, the shaft may also be an insulating solid shaft. The embodiments of the present disclosure do not limit the implementation of the shaft 14.

In other embodiments, the first body 11 and the second body 12 may also be connected in rotation based on other connection methods. The embodiments of the present disclosure do not limit the method for realizing relative rotation between the first body 11 and the second body 12.

In addition, in the embodiments of the present disclosure, the electronic device is a laptop computer as an example for illustration. The electronic device is not limited to a laptop computer, but may also be other electronic devices with a folding structure, such as a folding mobile phone and a folding wearable device. The embodiments of the present disclosure do not limit the implementation method of the electronic device.

In some embodiments, the signal of the first frequency band may be a high frequency signal, and the signal of the second frequency band may be a low frequency signal. For example, the frequency range of the low frequency signal may be 2.4 GHz-2.5 GHz, and the frequency range of the high frequency signal may be 5.15 GHz-5.85 GHz. The frequency range of the signal of the first frequency band and the signal of the second frequency band may be set based on needs and is not limited to the frequency range provided in the embodiments of the present disclosure, which is not limited in the present disclosure.

In some embodiments, the first body 11 may be a metal shell such that the electronic device has a first conductor side wall 111; the second body 12 may be a metal shell such that the electronic device has a second conductor side wall 121. In other embodiments, the first body 11 may include a first metal portion, the first metal portion including the first conductor side wall 111, and the second body 12 may include a second metal portion, the second metal portion including the second conductor side wall 121.

When the feeder 22 feeds the first conductor side wall 111, the feeder 22 can feed the first conductor side wall 111 based on coupling, or can directly feed the first conductor side wall 111 in an electrically connected manner, which is not limited in the embodiments of the present disclosure.

The first conductor side wall 111 and the second conductor side wall 121 may be rotatably connected at both ends of the gap 13 based on two active connectors. In addition, the rotating connector can be a metal member to achieve electrical contact between the first conductor side wall 111 and the second conductor side wall 121 at the rotating connection. In this way, the two conductor side walls can be constructed into a closed annular gap such that the radio frequency source connected to the feeder 22 can radiate the signal of the second frequency band through the second radiator.

It should be noted that in the embodiments of the present disclosure, the two bodies can be connected to each other by rotation based on two rotating connectors to form a closed annular gap structure. In other embodiments, the two bodies can be rotatably connected based on a rotating connector. In this case, the rotating connector may be located in the middle area of the two conductor side walls, and the two closed annular gap structures can be formed on both sides of the rotating connector.

In the embodiments of the present disclosure, in the same closed annular gap, in the second conductor side wall 121, two accommodating spaces 15 may be arranged in the area corresponding to the same gap 13 such that a single gap 13 can be excited to realize a dual antenna design and have good antenna performance. In addition, this design is suitable for metal shell structures and can share the existing shell structure of the electronic device to realize antenna design. The antenna occupies a small space and can meet the lightweight and compact design requirements of the electronic device. Further, this design can also achieve good antenna performance and meet the requirements of narrow bezel design. It is suitable for laptops with all-metal shells and has low requirements for shell materials and processes, which can greatly improve the appearance of the product.

In some embodiments, the accommodating space 15 may be configured to be a resonator, which is used to amplify the signal of the first frequency band radiated by the first radiator. Based on the design of the accommodating space 15, the accommodating space 15 can be used to amplify the signal of the first frequency band, thereby improving the radiation efficiency of the signal of the first frequency band.

In some embodiments, the accommodating space 15 may be a resonator formed by a conductive material disposed in the second conductor side wall 121. In this way, the conductive material is constructed as a resonator to amplify the signal of the first frequency band. To facilitate the process preparation and improve integration, the accommodating space 15 may be arranged to be a metal cavity formed in the second conductor side wall 121. The metal cavity has an opening facing the second conductor side wall 121. The metal cavity can be used as a resonator to enhance the reflection of the signal of the first frequency band, thereby amplifying the signal of the first frequency band.

In some embodiments, the accommodating space 15 may be arranged as a groove located in the second conductor side wall 121 such that the second conductor side wall 121 of the conductive material can be used to prepare the resonator. At this time, to ensure the resonance effect of the resonator on the signal of the first frequency band, the depth range of the groove can be set to 0 mm-5 mm. Within this range, the resonator has a good resonance effect on the signal of the first frequency band to ensure the communication quality of the signal of the first frequency band. In some embodiments, in the plane where the second conductor side wall 121 is located, the length of the groove may be 30 mm to 500 mm, and the width may be 2 mm to 8 mm. For example, the length and width of the groove may be 40 mm×5 mm. The depth of the groove can be set based on actual needs. The depth of the groove is not limited to 0 mm-5 mm, and can also be other value ranges, which is not limited in the embodiments of the present disclosure.

Take a laptop computer as an example. Based on the technical solution provided in the embodiments of the present disclosure, the antenna can be designed based on the gap 13 between the display screen body and the keyboard body of the laptop computer, an accommodating space 15 can be respectively arranged at the left and right ends of the gap 13 of the annular structure, and two feeders 22 can be corresponding arranged at the two accommodating spaces 15 to constructure two second radiators. In this way, the low frequency resonance bandwidth of the WLAN dual antenna can be simultaneously excited at the left and right ends of the gap 13. At the same time, the high frequency resonance bandwidth can be realized based on the accommodating space 15, and the design of two WLAN dual-band antennas can be realized by using the same gap 13. At the same time, the low frequency signal can be realized by using the gap 13 between the two metal shells. The antenna radiator design only needs to meet the coupling feeding design of the annular gap structure. There is no need to realize low frequency resonance through the antenna radiator, which facilitates the miniature design of the feeder 22.

For the laptop computer described in the embodiments of the present disclosure, the keyboard body can be a mechanical keyboard body, or a keyboard body with virtual keys implemented based on a display screen, which is not limited by the embodiments of the present disclosure.

The maximum size of the radiator in a conventional antenna is determined by the low frequency band antenna radiator. Since the wavelength of the low frequency band is the longest, a larger antenna radiator is required for the same performance level. The technical solution provided in the embodiments of the present disclosure can resonate low frequency signals based on the gap 13, and can significantly reduce the size of the feeder 22 such that a miniaturized design of the antenna radiator can be realized.

In other embodiments, when the signal of the first frequency band radiated by the radiator 21 can meet the communication requirements without amplification, the accommodating space 15 can also be constructed in the second conductor side wall 121 using non-conductive materials.

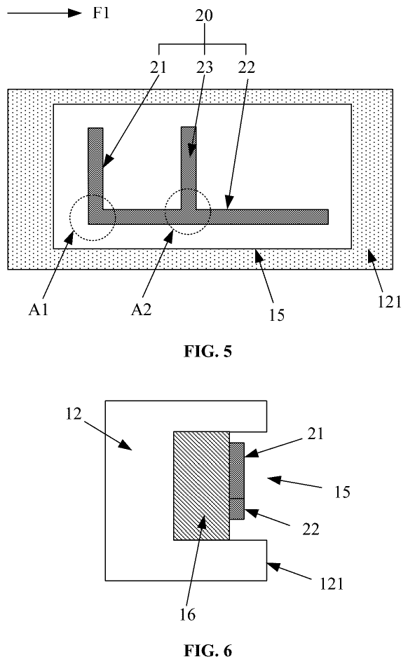

Refer to FIG. 5, which is a schematic diagram of a layout of a conductive member in an accommodating space according to some embodiments of the present disclosure. In view of the description of the foregoing drawings and FIG. 5, the radiator 21 may extend along a first direction, and the feeder 22 may extend along a second direction. A first connection point A1 and a second connection point A2 may be arranged on the feeder 22 in sequence in the second direction. One end of the radiator 21 may be integrally connected to the feeder 22 at the first connection point A1, and the other end may have a feeding point, which may be used to connect to the radio frequency source of the electronic device. The second connection point A2 may be connected to a ground branch 23. In some embodiments, the end of the ground branch 23 away from the second connection point A2 may be a ground point.

The first direction may be the length direction of the radiator 21, which is perpendicular to the direction F1 shown in FIG. 5. The second direction may be the length direction of the feeder 22, which is parallel to the direction F1 shown in FIG. 5.

In the embodiment shown in FIG. 5, the integrally formed conductive member 20 may be used as the antenna radiator, and different parts of the same conductive member 20 may be used as the radiator 21, the feeder 22, and the ground branch 23. Based on the conductive member, the radiator 21 and the second radiator can be based on the same feeding point and a second feeding point such that the radiator 21 and the second radiator can be connected to the radio frequency loop where the same radio frequency source is located. In this way, multi-band communication including a signal of the first frequency band and a signal of the second frequency band can be simultaneously realized based on the same conductive member 20.

In some embodiments, two accommodating spaces 15 may be symmetrically arranged at both ends of the second conductor side wall 121, and the conductive members 20 in the two accommodating spaces 15 may be symmetrically arranged. At this time, the two conductive members 20 can share the same gap 13 to realize the design of two WLAN antennas without connecting and dividing the gap 13, and can be applied to electronic devices with a shell having conductive properties (e.g., a metal shell, etc.). In the embodiments of the present disclosure, there is no need to arrange openings on the shell, which can meet the appearance requirement to the greatest extent and improve the product. Simulation data shows that based on the technical solution provided in the embodiments of the present disclosure, the working bandwidth of the two WLAN antennas can meet the requirements, and the isolation effect also meets the requirement.

The implementation of the radiator 21 and the feeder 22 is not limited to the arrangement shown in FIG. 5. In other implementations, the radiator 21 and the feeder 22 may also be two separate conductive members.

Refer to FIG. 6, which is a cross-sectional view of the electronic device in the accommodating space according to some embodiments of the present disclosure. The accommodating space 15 may be a groove formed on the second conductor side wall 121, and the electronic device may further include an insulator 16. The insulator 16 may be disposed in the accommodating space 15, and the radiator 21 and the feeder 22 may be disposed on the surface of the insulator 16 away from the bottom of the groove. The insulator 16 may be used to provide a clearance area between the radiator 21 and the feeder 22 and the inner wall of the accommodating space 15.

In some embodiments, the insulator 16 may be any insulating material such as tempered glass, plastic, wood material, ceramic material, etc., which is not limited in the embodiments of the present disclosure.

In the arrangement shown in FIG. 6, the accommodating space 15 is formed based on the groove in the surface of the second conductor side wall 121, the insulator 16 is arranged in the groove, and the radiator 21 and the feeder 22 are arranged on the surface of the insulator 16. In this way, a clearance area can be formed between the radiator 21 and the feeder 22 and the inner wall of the accommodating space 15 to prevent the conductor inner wall of the accommodating space 15 from affecting the communication quality of the signal of the first frequency band and the signal of the second frequency band.

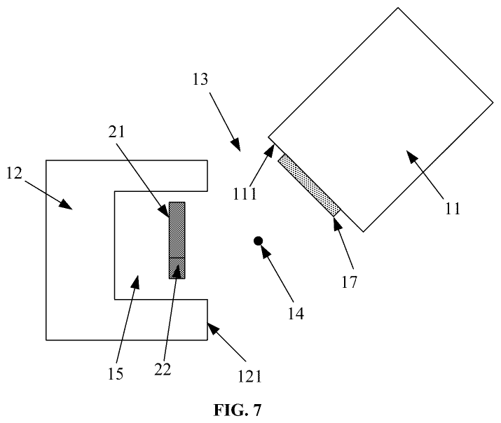

Refer to FIG. 7, which is a cross-sectional view of an enlarged portion of the electronic device in a direction perpendicular to the second conductor side wall according to some embodiments of the present disclosure. In some embodiments, the electronic device may further include a metamaterial module 17. The metamaterial module 17 may be disposed on the first conductor side wall 111, and the metamaterial module 17 may be coupled to the feeder 22 and/or the radiator 21. The metamaterial module 17 may have a negative refractive property, and the metamaterial module 17 may be used to change the radiation direction of the electromagnetic waves received by the feeder 22 and/or the radiator 21. In some embodiments, the metamaterial module 17 may be directly disposed on the surface of the first conductor side wall 111, and may be at least partially embedded in the surface of the first conductor side wall 111. The present disclosure does not limit the layout and pattern structure of the metamaterial module 17.

The metamaterial module 17 may be a metamaterial with negative refractive index characteristics, and its negative refractive index characteristics can be realized by regulating the internal microstructure. For example, the metamaterial module 17 may be a periodic composite material composed of a metal nanostructure and a dielectric material. The refractive index of the dielectric material is positive, while the electrons of the metal nanostructure make the effective refractive index of the metamaterial module 17 negative. It should be noted that the embodiments of the present disclosure do not limit the specific type of the metamaterial module 17, that is, those skilled in the art can adjust its type based on actual needs. The above description are merely examples of the types of applications of the metamaterial module 17 in the present disclosure, but the present disclosure is not limited thereto.

In the electronic device provided in embodiments of the present disclosure, the gap 13 between the two conductor side walls and the feeder 22 may be reused to form a second radiator for radiating the signal of the second frequency band. The second radiator is equivalent to a slot antenna structure. The gap 13 can be equivalent to an open resonator in the electromagnetic field such that the electromagnetic waves perpendicular to the length direction of the gap 13 can resonate in the gap 13, thereby enhancing the radiation effect. However, the resonance effect of the electromagnetic wave parallel to the length direction of the gap 13 is weak in the gap 13, resulting in a relatively weak radiation intensity of the electromagnetic wave in this direction. In this way, in the slot antenna structure, the radiation intensity of the electromagnetic signal in the direction perpendicular to the length of the gap 13 is relatively large, and the radiation intensity of the electromagnetic signal in the direction parallel to the length of the gap 13 is relatively small. In the arrangement shown in FIG. 7, based on the adjustment function of the metamaterial module 17 on the radiation direction of electromagnetic waves, the radiation intensity of electromagnetic signals in different radiation directions in the gap 13 can be balanced.

In the arrangement shown in FIG. 7, the metamaterial module 17 is coupled with the feeder 22 and/or the radiator 21, and the electromagnetic waves radiated by the feeder 22 and/or the radiator 21 are negatively refracted by utilizing the negative refractive index characteristics of the metamaterial module 17. The electromagnetic wave after negative refraction can be radiated in a direction parallel to the length of the gap 13, thereby increasing the radiation intensity of the electromagnetic wave in the direction parallel to the length of the gap 13.

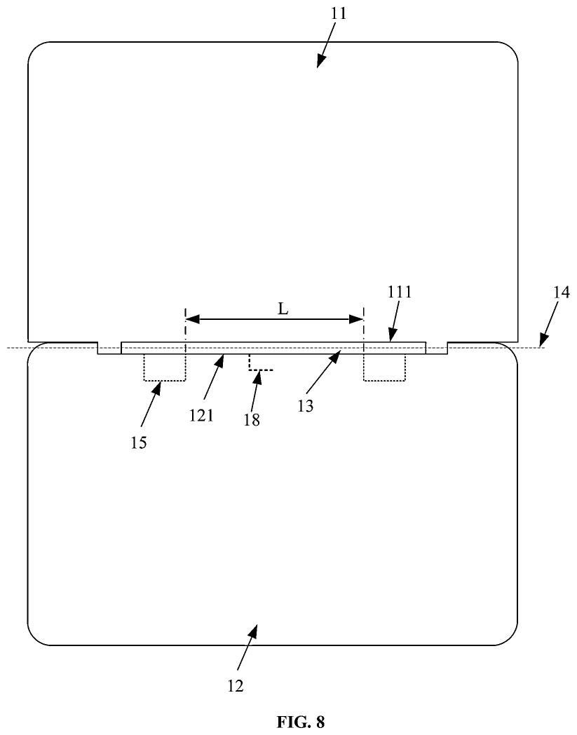

Refer to FIG. 8, which is a top view of the electronic device according to some embodiments of the present disclosure. FIG. 8 is a top view showing the first body 11 and the second body 12 being in the same plane or substantially in the same plane. On the basis of any of the foregoing embodiments, in the electronic device shown in FIG. 8, a plurality of accommodating spaces 15 may be arranged on the second conductor side wall 121, and a feeder 22 and a radiator 21 may be correspondingly arranged in each accommodating space 15. FIG. 8 does not show the feeder 22 and the radiator 21. For the arrangement of the feeder 22 and the radiator 21 in the accommodating space 15, reference can be made to the relative description in the foregoing embodiments.

In the embodiments of the present disclosure, the accommodating space may be located inside the second conductor side wall 121, or may be located in the second conductor side wall 121, and may protrude relative to the surface where the second conductor side wall 121 is located, which is not limited in the present disclosure.

In the arrangement shown in FIG. 8, the plurality of accommodating spaces 15 may be spaced apart and located on the second conductor side wall 121. In some embodiments, the electronic device may further include at least one insulation unit 18. The insulation unit 18 may be disposed between at least two of the plurality of accommodating spaces 15, and the insulation unit 18 may be electrically connected to the second conductor side wall 121. The insulation unit 18 may be used to reduce the electromagnetic coupling between at least two accommodating spaces 15. In some embodiments, the length of the insulation unit 18 may be one quarter of the first wavelength such that the isolation of the signal of the second frequency band corresponding to different second radiators can be improved through the insulation unit 18.

The insulation unit 18 serves as an isolation branch, which can reduce the electromagnetic coupling between two adjacent accommodating spaces 15 on the second conductor side wall 121. In this way, the isolation between the second radiators corresponding to the feeder 22 in two adjacent accommodating spaces 15 can be improved, thereby reducing the interference of the signal of the second frequency bands radiated by the two second radiators.

When the layout space of the second conductor side wall 121 is sufficient, any number of accommodating spaces 15 may be arranged on the second conductor side wall 121 based on needs. The number of accommodating spaces 15 includes, but is not limited to the two shown in FIG. 8.

In some embodiments, the insulation unit 18 may be disposed in the first body 11. The insulation unit 18 may be fixed to the first conductor side wall 111, electrically connected to the first conductor side wall 111, and electrically connected to the second conductor side wall 121 through the first conductor side wall 111. Alternatively, the insulation unit 18 may be disposed in the second body 12. The insulation unit 18 may be fixed on the second conductor side wall 121 and electrically connected to the second conductor side wall 121.

In the embodiments of the present disclosure, to prevent the insulation unit 18 from being damaged due to impact by external force, the insulation unit 18 may be located in the first body 11 or in the second body 12. In some embodiments, at least one insulation unit 18 may be arranged in the first body 11 and/or at least one insulation unit 18 may be arranged in the insulation unit 18 based on needs.

In some embodiments, in the second conductor side wall 121, as shown in FIG. 8, at least one accommodating space 15 may include a first accommodating space and a second accommodating space. In the two accommodating spaces 15 shown in FIG. 8, one may be the first accommodating space and the other may be the second accommodating space. The first accommodating space and the second accommodating space may be apart by a preset distance L, and the preset distance L may be no less than half of the first wavelength, the first wavelength may be the central wavelength of the signal of the second frequency band. Setting the preset distance L to be no less than half of the first wavelength can not only effectively excite the resonance of the gap 13 to the signal of the second frequency band to ensure radiation efficiency of the signal of the second frequency band, but also ensure that the feeder 22 in each of the first accommodating space and the second accommodating space has a sufficiently large space, thereby providing assistance in improving the isolation of the second radiator to realize the best radiation performance of the second radiator.

When an insulation unit 18 is disposed between the first accommodating space and the second accommodating space, the preset distance L may be set to be no less than half of the first wavelength, and the isolation effect of the second radiator may be further improved based on the auxiliary insulation unit 18. When the distance or space between the first accommodating space and the second accommodating space is insufficient to arrange the insulation unit 18, the isolation of the first radiator may be improved by setting a preset distance L that is no less than half of the first wavelength.

In the embodiments of the present disclosure, a closed annular gap 13 can be formed between the first conductor side wall 111 and the second conductor side wall 121 based on a rotating connector such that the feeder 22 can form a second radiator with the gap 13. The distance between the feeder 22 in the accommodating space 15 and the adjacent rotating connector may be set to be no less than one quarter of the first wavelength and no more than one half of the first wavelength. In this way, the signal of the second frequency band can be excited to resonate based on the gap 13 corresponding to the feeder 22 to ensure the radiation efficiency of the signal of the second frequency band.

Based on any of the foregoing embodiments, one of the first conductor side wall 111 and the second conductor side wall 121 may be set as a first curved surface. The first curved surface may be bent toward the other of the first conductor side wall 111 and the second conductor side wall 121. For example, one of the first conductor side wall 111 and second conductor side wall 121 may be set as a flat surface and the other may be a convex curved surface. The convex surface may be bent toward the plane to reduce the width of the gap 13 such that the gap 13 can better excite the signal of the second frequency band and improve the radiation performance of the second radiator. In addition, the smaller gap 13 can make the electronic device more compact, which improves the aesthetic appearance of the electronic device.

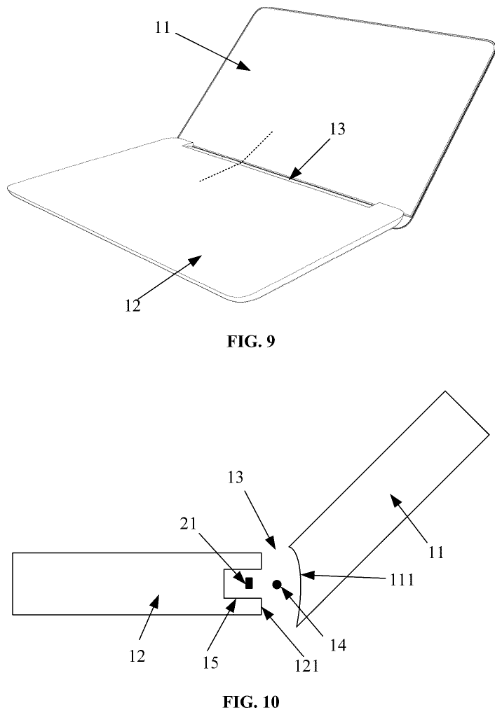

FIG. 9 is another schematic structural diagram of the electronic device according to some embodiments of the present disclosure, and FIG. 10 is a cross-sectional view of the electronic device shown in FIG. 9 along the dotted line direction. As shown in FIG. 10, the first conductor side wall 111 is a curved surface, and the second conductor side wall 121 is a flat surface. The first conductor side wall 111 with a curved surface structure is bent toward the second conductor side wall 121 with a flat surface structure. Based on the curved surface design of the first conductor side wall 111, the first conductor side wall 111 is bent toward the second conductor side wall 121 such that the first conductor side wall 111 can be closer to the feeder 22 in the accommodating space 15. In this way, the gap 13 can be used to better excite the signal of the second frequency band and improve the radiation performance of the second radiator. In addition, the curved surface design of the first conductor side wall 111 can enable the electronic device to achieve a compact appearance, and can make the appearance of the electronic device more beautiful.

The second conductor side wall 121 may be set as a curved surface, and the first conductor side wall 111 may be set as a flat surface. The second conductor side wall 121 with a curved surface structure may be bent toward the first conductor side wall 111 with a flat surface structure. This arrangement can also make the first conductor side wall 111 closer to the feeder 22 in the accommodating space 15, thereby better exciting the signal of the second frequency band by utilizing the gap 13 and improving the radiation performance of the second radiator. At the same time, the electronic device can achieve a compact appearance, and can make the appearance of the electronic device more beautiful.

In some embodiments, the signal of the first frequency band may be a high frequency or medium frequency signal (e.g., 2.4 GHz), and the radiation of the high frequency or medium frequency signal (e.g., 5 GHz) may be realized based on the first radiator. The signal of the second frequency band may be a low frequency signal, and the radiation of the low frequency signal may be realized based on the feeder 22 and the gap 13. When the electronic device is a laptop computer, the gap 13 may be formed by the metal shell of the display screen and the metal shell of the laptop keyboard in the laptop computer. The length and width of the gap 13 may be set to meet the radiation requirements of the low frequency signal. Exciting the gap 13 can generate a strong loop current to achieve effective radiation of the low frequency signal. Adjusting the characteristics of the radiator 21 can excite the WLAN low frequency signal and achieve good bandwidth and radiation performance.

The upper cover (or shell A) and the lower covers (or shell C and shell D) of a conventional laptop computer are only connected by rotation, and there is no closed annular gap structure between the metal shells that is electrically connected. The antenna located in the shell C and shell D areas cannot be directly fed to the shell A to excite the gap structure. In the embodiments of the present disclosure, a specific gap coupling feeding method can be used to excite the gap 13 between the shell A and shell C and shell D.

Consistent with the present disclosure, shell A can be brought as close to shell C and shell D as possible, and the width of the gap 13 can be reduced as much as possible such that the feeder 22 can be closer to the first conductor side wall 111 for the gap 13 to obtain sufficient coupling energy.

In some embodiments, in the direction perpendicular to the second conductor side wall 121, the distance between the feeder 22 and the first conductor side wall 111 may be in the range of 1 mm-3 mm such that the feeder 22 can be closer to the first conductor side wall 111 for the gap 13 to obtain sufficient coupling energy. Based on the current simulation data of the electronic device in the gap 13, the current is strongest along the surface area of the gap 13, which can achieve effective radiation of low frequency signals.

In some embodiments, the first conductor side wall 111 and the second conductor side wall 121 may both be set as second curved surfaces, and the two second curved surfaces may be bent toward each other to reduce the width of the gap 13. At this time, at least one of the first conductor side wall 111 and the second conductor side wall 121 is a convex surface. For example, one of the surfaces may be a concave surface and the other a convex surface, and the concave surface surrounds the convex surface to reduce the width of the gap 13. In this way, the gap 13 can better excite the signal of the second frequency band and improve the radiation performance of the second radiator. In addition, the smaller gap 13 can make the electronic device more compact, which improves the aesthetic appearance of the electronic device.

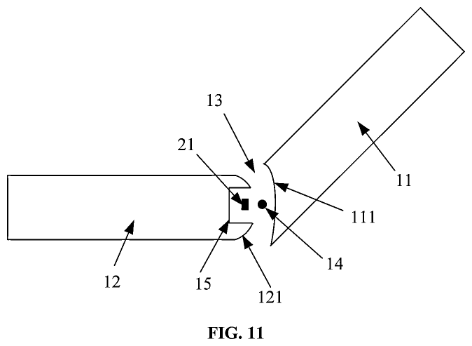

If one of the first conductor side wall 111 and the second conductor side wall 121 is a concave surface and the other is a convex surface, and the concave surface surrounds the convex surface, the structure of the electronic device may be arranged as shown in FIG. 11.

FIG. 11 is a cross-sectional view of the electronic device along the direction perpendicular to the second conductor side wall according to some embodiments of the present disclosure. As shown in FIG. 11, the first conductor side wall 111 is a concave surface, and the second conductor side wall 121 is a convex surface. The first conductor side wall 111 with a concave surface structure surrounds the second conductor side wall 121 with a convex surface structure. In this way, the first conductor side wall 111 can be closer to the feeder 22 in the accommodating space 15 such that the signal of the second frequency band can be better excited by the gap 13, thereby improving the radiation performance of the second radiator. In addition, the curved surface design of the first conductor side wall 111 can enable the electronic device to achieve a compact appearance, and can make the appearance of the electronic device more beautiful.

In some embodiments, when one of the first conductor side wall 111 and the second conductor side wall 121 is a concave surface and the other is a convex surface, and the concave surface surrounds the convex surface, the second conductor side wall 121 may be set as a concave surface, and the first conductor side wall 111 may be set as a convex surface such that the second conductor side wall 121 with a concave surface structure surrounds the first conductor side wall 111 with a convex surface structure. This arrangement can also make the first conductor side wall 111 closer to the feeder 22 in the accommodating space 15, thereby better exciting the signal of the second frequency band by utilizing the gap 13 and improving the radiation performance of the second radiator. At the same time, the electronic device can achieve a compact appearance, and can make the appearance of the electronic device more beautiful.

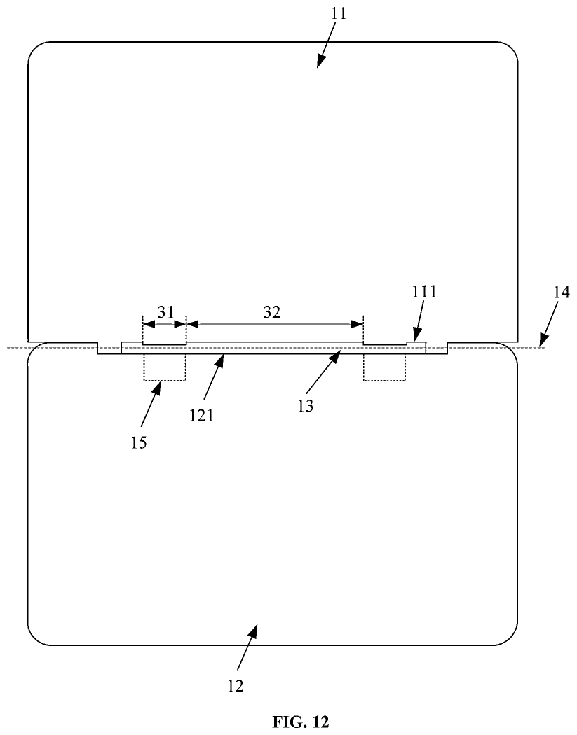

Refer to FIG. 12, which is another schematic structural diagram of the electronic device according to some embodiments of the present disclosure. Based on the foregoing embodiments, in the electronic device shown in FIG. 12, the first conductor side wall 111 includes a first part 31 and a second part 32. In a direction perpendicular to the second conductor side wall 121, the first part 31 corresponds to the accommodating space 15, the minimum distance between the first part 31 and the accommodating space 15 is a first distance, and the minimum distance between the second part 32 and the second conductor side wall 121 is a second distance. The first distance may be smaller than the second distance. In this arrangement, the first part 31 and the second part 32 of the first conductor side wall 111 may be configured to be differentially arranged such that the first distance is smaller than the second distance. In this way, the feeder 22 in the accommodating space 15 has a smaller distance from the first conductor side wall 111 in a direction perpendicular to the second conductor side wall 121. Therefore, the feeder 22 in the accommodating space 15 is closer to the first conductor side wall 111 such that the signal of the second frequency band can be better excited by the gap 13, thereby improving the radiation performance of the second radiator.

In the arrangement shown in FIG. 12, the first part 31 is arranged closer to the second conductor side wall 121 than the second part 32 such that the first distance is smaller than the second distance. In some embodiments, the first part 31 may be a curved surface that bends toward the second conductor side wall 121, and the second part 32 may be a flat surface such that the first distance is smaller than the second distance.

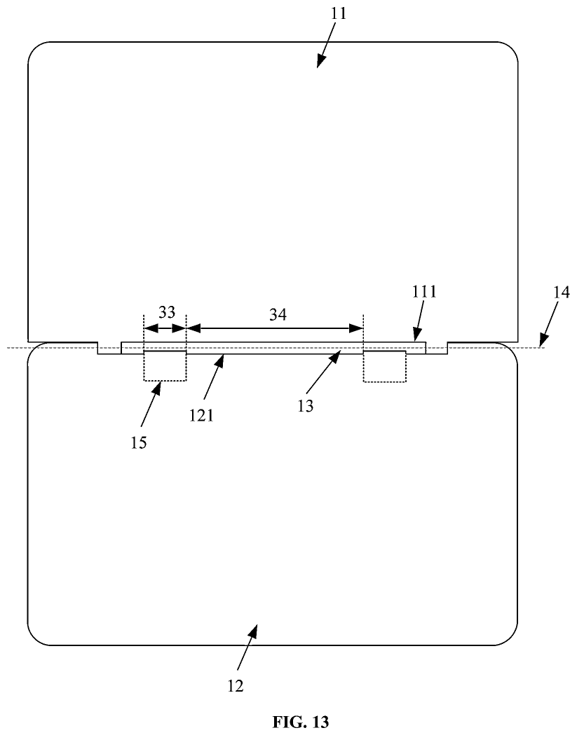

Refer to FIG. 13, which is another schematic structural diagram of the electronic device according to some embodiments of the present disclosure. Based on the foregoing embodiments, in the electronic device shown in FIG. 13, the second conductor side wall 121 includes a third part 33 and a fourth part 34, the accommodating space 15 being arranged in the third part 33; in a direction perpendicular to the second conductor side wall 121, the minimum distance between the third part 33 and the first conductor side wall 111 is a third distance, and the minimum distance between the fourth part 34 and the first conductor side wall 111 is a fourth distance. The third distance may be smaller than the fourth distance. In this arrangement, the third part 33 and the fourth part 34 of the second conductor side wall 121 may be configured to be differentially arranged such that the third distance is smaller than the fourth distance. In this way, the feeder 22 in the accommodating space 15 is closer to the first conductor side wall 111 such that the signal of the second frequency band can be better excited by the gap 13, thereby improving the radiation performance of the second radiator.

In the arrangement shown in FIG. 13, the third part 33 is arranged closer to the first conductor side wall 111 than the fourth part 34 such that the third distance is smaller than the fourth distance. In some embodiments, the third part 33 may be a curved surface that bends toward the first conductor side wall 111, and the fourth part 34 may be a flat surface such that the third distance is smaller than the fourth distance.

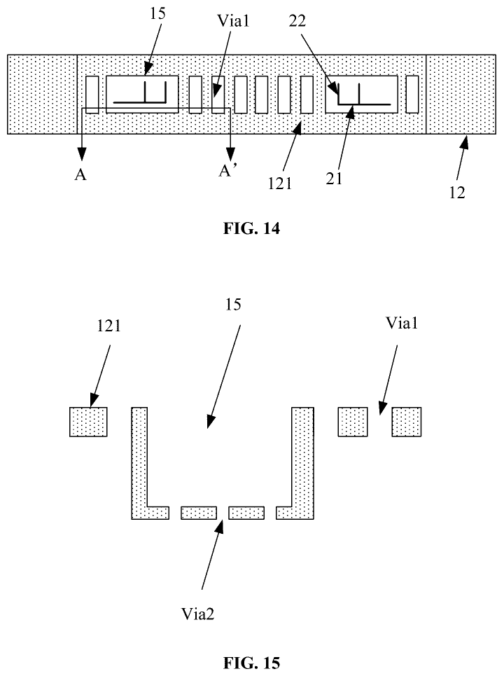

FIG. 14 is a front view of the electronic device facing the second conductor side wall according to some embodiments of the present disclosure. FIG. 15 is a cross-sectional view of FIG. 14 along the A-A′ direction. Refer to FIG. 14 and FIG. 15, based on the foregoing embodiments, the second conductor side wall 121 includes a first heat dissipation via Via1; the accommodating space 15 is a groove arranged in the second conductor side wall 121, and the bottom of the groove has a second heat dissipation via Via2. The maximum line width of the second heat dissipation via Via2 may not be greater than one tenth of the second wavelength. The maximum line width of the second heat dissipation via Via2 may refer to the length of the longest straight line within the opening range of the second heat dissipation via Via2. The second wavelength may be the central wavelength of the signal of the first frequency band. in the embodiments of the present disclosure, based on the design requirements of the electronic device, the electronic device may include at least one of the first heat dissipation via Via1 and the second heat dissipation via Via2. It should be noted that the opening shape of the first heat dissipation via Via1 and/or the second heat dissipation via Via2 is not limited to the rectangular shape shown in FIG. 14 and FIG. 15. In other embodiments, the opening shape of the first heat dissipation via Via1 and/or the second heat dissipation via Via2 may also be circular, trapezoidal, polygonal or irregular, etc., which is not limited in the embodiments of the present disclosure.

The first heat dissipation via Via1 and the second heat dissipation via Via2 can improve the heat dissipation efficiency of the electronic device in the first body 11. When arranging the second heat dissipation via Via2, the maximum line width of the second heat dissipation via Via2 may be set to be no greater than one tenth of the second wavelength such that the accommodating space 15 can act as a resonator to reflect the signal of the first frequency band, thereby preventing the second heat dissipation via Via2 from affecting the reflection effect of the accommodating space 15 on the signal of the first frequency band.

Based on any of the foregoing implementations, in the embodiments of the present disclosure, the radiator 21 and the feeder 22 may be an inverted-F antenna radiator with an integrated structure. The signal of the first frequency band may be a high frequency signal or a medium frequency signal, and the signal of the second frequency band may be a low frequency signal. Based on the inverted-F antenna radiator, the structural design of the radiator 21 and the feeder 22 in the embodiments of the present disclosure can be simultaneously realized, and multi-band communication requirements can be simultaneously realized based on the same inverted-F antenna radiator.

More specifically, the inverted-F antenna can use the radiator 21 as the high frequency branch radiator, and the high frequency branch radiator can radiate high frequency or medium frequency signals. The inverted-F antenna can also be used as a low frequency branch radiator through the feeder 22, and the low frequency branch radiator and the gap 13 can form the second radiator to radiate low frequency signals.

As described above, the electronic device provided in the embodiments of the present disclosure can be a laptop computer, a foldable mobile phone, a foldable wearable device, or other electronic devices with a foldable function.

Take a laptop computer as an example. The first body 11 may be a display screen of a laptop computer, and the second body 12 may be a keyboard body of the laptop computer. Based on the technical solution of the present disclosure, the antenna radiator can be arranged based on the rotating connection structure of the laptop computer display screen body and the keyboard body, which can meet the full metal shell design of the laptop computer, and the antenna radiator size can be miniaturized based on the accommodating space 15 to save system space. Further, the gap 13 formed between the metal shell of the display screen body and the metal shell of the keyboard body can be used to construct a second radiator. When two accommodating spaces 15 are symmetrically arranged on the second conductor side wall 121, two second radiators can be constructed based on the two feeders 22, and the gap 13 can be used to realize the resonance bandwidth of the WLAN low frequency band (e.g., the signal of the second frequency band), and the resonance bandwidth of the high frequency band (e.g., the signal of the first frequency band) can also be realized based on the accommodating space 15. Based on the above design for improving isolation, a dual WLAN antenna design can be implemented in a laptop computer by utilizing a gap 13 in an annular structure between two metal shells.

In addition, the low frequency feeder 22 can use conventional structure to achieve extreme miniaturization, and is suitable for the design of a full metal shell of the whole machine. The appearance design is not limited by materials and processes, and can meet the design requirements of new laptop computers such as thin, lightweight and all-metal frames, which can improve produce performance and enhance product appearance.

In some embodiments, the antenna design may be realized by using the gap annular structure formed by the upper and lower metal casings of the foldable electronic device (e.g., a laptop computer, etc.). In addition, the left and right sides of the gap annular structure are simultaneously excited to realize the low frequency resonance bandwidth of the WLAN dual antenna, and the high frequency resonance bandwidth can be realized in conjunction with the miniaturized cavity environment. The design of two WLAN dual-band antenna is realized using the same gap annular structure. At the same time, since the low frequency band is realized in a shared casing environment, the antenna body design only needs to meet the coupled feeding design of the gap annular structure, without the need to achieve low frequency resonance through the antenna body. Therefore, this design can facilitate the miniaturization of antenna size. Generally, the maximum size of a multi-frequency antenna is determined by the lowest operating frequency band. The wavelength of the low frequency band is the longest, and the antenna size (opening) required for the same performance level is the largest. In some embodiments, take a laptop computer as an example, the size and structure of the laptop computer body determine that the length and width of the gap are sufficient to realize effective lower frequency radiation. Exciting the gap can generate a strong loop current to achieve effective radiation. Adjusting the characteristics of the excitation component can excite the WLAN low frequency band and achieve good bandwidth and radiation performance.

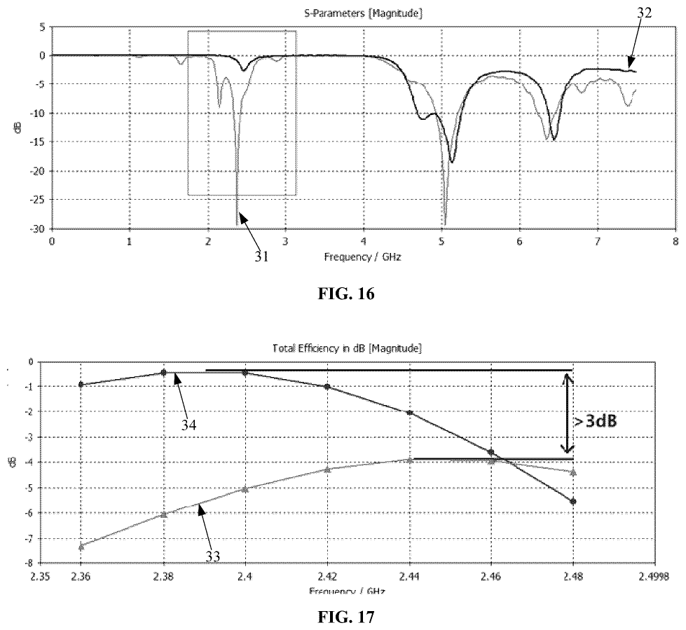

Refer to FIG. 16, which is a return loss curve of an antenna radiator. Take a laptop computer as an example. When the laptop computer removes the shell A, the antenna return loss is shown as curve 22. When the laptop computer retains the shell A and radiates low frequency signals based on the gap 13, the return loss is shown as curve 21. Based on the comparison between curve 21 and curve 22 in FIG. 16, it can be seen that for the low frequency signal in the 2.4 GHz frequency band, the low frequency signal radiation effect without the gap 13 is poor. Most of the energy is returned due to mismatch and is not received by the antenna radiator. The more energy the antenna radiator receives, the more it can radiate.

Refer to FIG. 17, which is a reflection coefficient curve of the antenna radiator. Continue to use a laptop computer as an example. When the laptop computer removes the shell A, the antenna reflection coefficient is shown as curve 23. When the laptop computer retains the shell A and radiates a low frequency signa based on the gap 13, the reflection coefficient is shown as curve 24. Based on the comparison between curve 23 and curve 24 in FIG. 17, it can be seen that for the low frequency signal in the 2.4 GHz frequency band, the reflection coefficient of the low frequency signal without gap 13 is poor, and the reflection coefficient difference between the two curves in the 2.4 GHz frequency band is greater than 3 dB.

Various embodiments of the present disclosure are described in a progressive manner, or in a parallel manner, or in a combination of progressive and parallel manners. Each embodiment may focus on differences from other embodiments, and same and similar parts between various embodiments may be referred to each other.

It should be noted that the drawings and the embodiments in the description of the present application are illustrative rather than restrictive. Like reference numerals identify like structures throughout the embodiments in this specification. In addition, for understanding and ease of description, some layers, films, panels, and areas may be exaggerated in thickness in the drawings. It should further be understood that an element such as a layer, film, area, or substrate referred to as being “on” another element may be directly or indirectly on the other element. In addition, “on” means to arrange one element on or under another, rather than essentially means to arrange one element on another according to the direction of gravity.

The orientation or positional relationship indicated by terms “upper”, “lower”, “top”, “bottom”, “inner”, “outer”, etc. are based on the orientation or positional relationship shown in the drawings, and are only for the convenience of describing the present application and a simplified description instead of indicating or implying that the device or element must be arranged, constructed or operated to a particular orientation, and therefore should not be construed as limiting the present application. A component that is considered to be “connected to” another component may be directly or indirectly connected to the other component.

It should also be noted that in the present disclosure, relational terms such as first, second and the like may be merely used to distinguish one entity or operation from another entity or operation and may not necessarily require or imply any such actual relationship or order between these entities or operations. Moreover, the terms “include”, “contain” or any other variations thereof may be intended to cover non-exclusive inclusion, so that a process, method, article, or equipment that includes a series of elements includes not only those elements, but also other elements that are not explicitly listed, or also includes elements inherent to the process, method, article, or equipment. If there are no more restrictions, the elements defined by the sentence “include a . . . ” does not exclude the existence of other same elements in the process, method, article, or equipment that includes the elements.

The above description of disclosed embodiments may enable those skilled in the art to make or use the present disclosure. Various modifications to these embodiments may be readily apparent to those skilled in the art, and the generic principles defined herein may be implemented in other embodiments without departing from the spirit or scope of the present disclosure. Therefore, the present disclosure may not be intended to be limited to embodiments of the present disclosure but may be accorded the widest scope consistent with the principles and novel features disclosed herein.

What is claimed is:

1. An electronic device comprising:
a first body; and
a second body, the second body being configured to rotate relative to the first body, wherein:
the first body has a first conductor side wall, the second body has a second conductor side wall, and a gap is formed between the first conductor side wall and the second conductor side wall;
the second conductor side wall has at least one accommodating space, each of the accommodating space has an opening in a direction perpendicular to the second conductor side wall, and a first radiator and a feeder are arranged in each of the accommodating spaces; and
the first radiator radiates a signal of a first frequency band, the feeder is configured to feed power to the first conductor side wall to cause the second radiator to radiate a signal of a second frequency band.

2. The electronic device of claim 1, wherein:
the accommodating space is configured to be a resonator, the resonator being configured to amplify the signal of the first frequency band radiated by the first radiator.

3. The electronic device of claim 1, wherein:
the first radiator extends along a first direction, the feeder extends along a second direction, and a first connection point and a second connection point being sequentially arranged on the feeder in the second direction; and
one end of the first radiator is integrally connected to the feeder at the first connection point, and the other end of the feeder has a feeding point, the feeding point being configured to connect to a radio frequency source of the electronic device, the second connection point being connected to a ground branch.

4. The electronic device of claim 3, wherein:
the accommodating space is a groove formed on the second conductor side wall, and the electronic device further comprising:
an insulator, the insulator being arranged in the accommodating space, wherein:
the first radiator and the feeder are arranged on a surface of the insulator away from the bottom of the groove, and the insulator is configured to provide a clearance area between the first radiator and the feeder and an inner wall of the accommodating space.

5. The electronic device of claim 1 further comprising:
a metamaterial module having a negative refraction characteristic, the metamaterial module being arranged on the first conductor side wall and coupled with the feeder and/or the first radiator, the metamaterial module being configured to change radiation direction of an electromagnetic wave received by the feeder and/or the first radiator.

6. The electronic device of claim 5, wherein:
a plurality of accommodating spaces are spaced apart and located on the second conductor side wall, the electronic device further comprising:
at least one insulation unit, the insulation unit being disposed between at least two of the plurality of accommodating spaces, and electrically connected to the second conductor side wall, the insulation unit being configured to reduce electromagnetic coupling between the at least two accommodating spaces.

7. The electronic device of claim 6, wherein:
the at least one accommodating space includes a first accommodating space and a second accommodating space, the first accommodating space and the second accommodating space being a preset distance apart, the preset distance being no less than half of a first wavelength, the first wavelength being a central wavelength of the signal of the second frequency band.

8. The electronic device of claim 1, wherein:
one of the first conductor side wall and second conductor side wall is a first curved surface, the first curved surface being bent toward the other of the first conductor side wall and the second conductor side wall; and/or
the first conductor side wall and the second conductor side wall are both second curved surfaces, the two second curved surfaces being bent toward each other; and/or
the first conductor side wall includes a first part and a second part, the first part corresponding to the accommodating space in the direction perpendicular to the second conductor side wall, a minimum distance between the first part and the accommodating space being a first distance, a minimum distance between the second part and the second conductor side wall being a second distance, the first distance being smaller than the second distance; and/or
the second conductor side wall includes a third part and a fourth part, the third part including the accommodating space in the direction perpendicular to the second conductor side wall, a minimum distance between the third part and the first conductor side wall being a third distance, a minimum distance between the fourth part and the second conductor side wall being a fourth distance, the third distance being smaller than the fourth distance.

9. The electronic device of claim 1, wherein:
the second conductor side wall includes a first heat dissipation via; and/or,
the accommodating space is a groove arranged in the second conductor side wall, a second heat dissipation via being arranged on the bottom of the groove, a maximum line width of the second heat dissipation via being no greater than one tenth of a second wavelength, the second wavelength being a central wavelength of the signal of the first frequency band.

10. The electronic device of claim 1, wherein:
the first radiator and the feeder are an inverted-F antenna radiator with an integrated structure, the signal of the first frequency band is a high frequency signal or a medium frequency signal, and the signal of the second frequency band is a low frequency signal.
